(19) United States
(12) Patent Application Publication
(10) Pub. No.: US 2007/0232257 A1
(43) Pub. Date: Oct. 4, 2007

(54) Noise suppressor

(76) Inventors: Takeshi Otani, Kawasaki (JP); Mitsuyoshi Matsubara, Fukuoka (JP); Kaori Endo, Kawasaki (JP); Yasuji Ota, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/727,062

(22) Filed: Mar. 23, 2007

Related U.S. Application Data
(63) Continuation of application No. PCT/JP04/16027, filed on Oct. 28, 2004.

(51) Int. Cl. H04Q 7/20

(52) U.S. Cl. 455/403

(57) ABSTRACT

A noise suppressor includes a frequency division part dividing an input signal into bands and outputting band signals; an amplitude calculation part determining amplitude components of the band signals; a noise estimation part estimating an amplitude component of noise contained in the input signal and determining an estimated noise amplitude component for each band; a weighting factor generation part generating a different weighting factor for each band; an amplitude smoothing part determining smoothed amplitude components that are the amplitude components of the band signals temporally smoothed using the weighting factors; a suppression calculation part determining a suppression coefficient from the smoothed amplitude component and the estimated noise amplitude component for each band; a noise suppression part suppressing the band signals based on the suppression coefficients; and a frequency synthesis part synthesizing and outputting the band signals of the bands after the noise suppression output from the noise suppression part.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2004/016027, filed on Oct. 28, 2004, the entire contents of which are hereby incorporated by reference.

### BACKGROUND OF THE INVENTION

1. Field of the Invention

The present invention relates to noise suppressors and to a noise suppressor that reduces noise components in a voice signal with overlapping noise.

2. Description of the Related Art

In cellular phone systems and IP (Internet Protocol) telephone systems, ambient noise is input to a microphone in addition to the voice of a speaker. This results in a degraded voice signal, thus impairing the clarity of the voice. Therefore, techniques have been developed to improve speech quality by reducing noise components in the degraded voice signal. (See, for example, Non-Patent Document 1 and Patent Document 1.)

FIG. 1 is a block diagram of a conventional noise suppressor. In the drawing, for each unit time (frame), a time-to-frequency conversion part 10 converts the input signal xₙ(k) of a current frame n from a time domain k to a frequency domain f and determines the frequency domain signal Xₙ(f) of the input signal. An amplitude calculation part 11 determines the amplitude component |Xₙ(f)| of the input signal (hereinafter referred to as “input amplitude component”) from the frequency domain signal Xₙ(f). A noise estimation part 12 determines the amplitude component μₙ(f) of estimated noise (hereinafter referred to as “estimated noise amplitude component”) from the input amplitude component |Xₙ(f)| of the case of no speaker's voice.

A suppression coefficient calculation part 13 determines a suppression coefficient Gₙ(f) from |Xₙ(f)| and μₙ(f) in accordance with Eq. (1):

$${G}_{n} ( f ) = 1 - \frac{{μ}_{n} ( f )}{\vert {X}_{n} ( f ) \vert} . \qquad ( 1 )$$

A noise suppression part 14 determines an amplitude component S*ₙ(f) after noise suppression from Xₙ(f) and Gₙ(f) in accordance with Eq. (2):
S*ₙ(f)=Xₙ(f)×Gₙ(f). (2)

A frequency-to-time conversion part 15 converts S*ₙ(f) from the frequency domain to the time domain, thereby determining a signal s*ₙ(k) after the noise suppression.

(Non-Patent Document 1) S. F. Boll, “Suppression of Acoustic Noise in Speech Using Spectral Subtraction,” IEEE Transaction on Acoustics, Speech, and Signal processing, ASSP-33, vol. 27, pp. 113-120, 1979

(Patent Document 1) Japanese Laid-Open Patent Application No. 2004-20679

In FIG. 1, the estimated noise amplitude component μₙ(f) is determined by, for example, averaging the amplitude components of input signals in past frames that do not include the voice of a speaker. Thus, the average (long-term) trend of background noise is estimated based on past input amplitude components.

FIG. 2 shows a principle diagram of a conventional suppression coefficient calculation method. In the drawing, a suppression coefficient calculation part 16 determines the suppression coefficient Gₙ(f) from the amplitude component |Xₙ(f)| of the current frame n and the estimated noise amplitude component μₙ(f). The input amplitude component is multiplied by this suppression coefficient, thereby suppressing a noise component contained in the input signal.

However, it is difficult to determine the amplitude component of (short-term) noise overlapping the current frame with accuracy. That is, there is an estimation error between the amplitude component of noise overlapping the current frame and the estimated noise amplitude component (hereinafter, noise estimation error). Therefore, as shown in FIG. 3, the noise estimation error, which is the difference between the amplitude component of noise indicated by a solid line and the estimated noise amplitude component indicated by a broken line, increases.

As a result, the above-described noise estimation error causes excess suppression or insufficient suppression in the noise suppressor. Further, since the noise estimation error greatly varies from frame to frame, excess suppression or insufficient suppression also varies, thus causing temporal variations in noise suppression performance. These temporal variations in noise suppression performance cause abnormal noise known as musical noise.

FIG. 4 shows a principle diagram of another conventional suppression coefficient calculation method. This is an averaging noise suppression technology having an object of suppressing abnormal noise resulting from excess suppression or insufficient suppression in the noise suppressor. In the drawing, an amplitude smoothing part 17 smoothes the amplitude component |Xₙ(f)| of the current frame n, and a suppression coefficient calculation part 18 determines the suppression coefficient Gₙ(f) based on the smoothed amplitude component Pₙ(f) of the input signal (hereinafter referred to as “smoothed amplitude component) and the estimated noise amplitude component μₙ(f).

The following two methods are employed as methods of smoothing an amplitude component.

(First Smoothing Method)

The average of the input amplitude components of a current frame and past several frames is defined as the smoothed amplitude component Pₙ(f). This method is simple averaging, and the smoothed amplitude component can be given by Eq. (3):

$${P}_{n} ( f ) = \frac{1}{M} {\sum }_{k = 0}^{N - 1} \vert {X}_{n - k} ( f ) \vert , \qquad ( 3 )$$

where M is the range (number of frames) to be subjected to smoothing.

(Second Smoothing Method)

The weighted average of the amplitude component |Xₙ(f)| of a current frame and the smoothed amplitude component Pₙ₋₁(f) of the immediately preceding frame is defined as the smoothed amplitude component Pₙ(f). This is called exponential smoothing, and the smoothed amplitude component can be given by Eq. (4):
Pₙ(f)=α×|Xₙ(f)|+(1−α)×Pₙ₋₁(f), (4)
where α is a smoothing coefficient.

According to the suppression coefficient calculation method of FIG. 4, when there is no inputting of the voice of a speaker, the noise estimation error, which is the difference between the amplitude component of noise indicated by a solid line and the estimated noise amplitude component indicated by a broken line, can be reduced as shown in FIG. 5 by performing averaging or exponential smoothing on input amplitude components before calculating the suppression coefficient. As a result, it is possible to suppress excess suppression or insufficient suppression at the time of noise input, which is a problem in the suppression coefficient calculation of FIG. 2, so that it is possible to suppress musical noise.

However, when there is inputting of the voice of a speaker, the smoothed amplitude component is weakened, so that the difference between the amplitude component of the voice signal indicated by a broken line and the smoothed amplitude component indicated by a broken line (hereinafter referred to as “voice estimation error”) increases as shown in FIG. 6.

As a result, the suppression coefficient is determined based on the smoothed amplitude component of a great voice estimation error and the estimated noise amplitude, and the input amplitude component is multiplied by the suppression coefficient. This causes a problem in that the voice component contained in the input signal is erroneously suppressed so as to degrade voice quality. This phenomenon is particularly conspicuous at the head of a voice (the starting section of a voice).

### SUMMARY OF THE INVENTION

Embodiments of the present invention may solve or reduce one or more of the above-described problems.

According to one embodiment of the present invention, there is provided a noise suppressor in which one or more of the above-described problems are solved or reduced.

According to one embodiment of the present invention, there is provided a noise suppressor that minimizes effects on voice while suppressing generation of musical noise so as to realize stable noise suppression performance.

According to one embodiment of the present invention, there is provided a noise suppressor including a frequency division part configured to divide an input signal into a plurality of bands and output band signals; an amplitude calculation part configured to determine amplitude components of the band signals; a noise estimation part configured to estimate an amplitude component of noise contained in the input signal and determine an estimated noise amplitude component for each of the bands; a weighting factor generation part configured to generate a different weighting factor for each of the bands; an amplitude smoothing part configured to determine smoothed amplitude components, the smoothed amplitude components being the amplitude components of the band signals that are temporally smoothed using the weighting factors; a suppression calculation part configured to determine a suppression coefficient from the smoothed amplitude component and the estimated noise amplitude component for each of the bands; a noise suppression part configured to suppress the band signals based on the suppression coefficients; and a frequency synthesis part configured to synthesize and output the band signals of the bands after the noise suppression output from the noise suppression part.

According to one embodiment of the present invention, there is provided a noise suppressor including a frequency division part configured to divide an input signal into a plurality of bands and output band signals; an amplitude calculation part configured to determine amplitude components of the band signals; a noise estimation part configured to estimate an amplitude component of noise contained in the input signal and determine an estimated noise amplitude component for each of the bands; a weighting factor generation part configured to cause weighting factors to temporally change and outputting the weighting factors; an amplitude smoothing part configured to determine smoothed amplitude components, the smoothed amplitude components being the amplitude components of the band signals that are temporally smoothed using the weighting factors; a suppression calculation part configured to determine a suppression coefficient from the smoothed amplitude component and the estimated noise amplitude component for each of the bands; a noise suppression part configured to suppress the band signals based on the suppression coefficients; and a frequency synthesis part configured to synthesize and output the band signals of the bands after the noise suppression output from the noise suppression part.

According to the above-described noise suppressors, generation of musical noise is suppressed while minimizing effects on voice, so that it is possible to realize stable noise suppression performance.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a conventional noise suppressor;

FIG. 2 is a principle diagram of a conventional suppression coefficient calculation method;

FIG. 3 is a diagram for illustrating conventional noise estimation error;

FIG. 4 is a principle diagram of another conventional suppression coefficient calculation method;

FIG. 5 is a diagram for illustrating conventional noise estimation error;

FIG. 6 is a diagram for illustrating conventional voice estimation error;

FIG. 7 is a principle diagram of suppression coefficient calculation according to the present invention;

FIG. 8 is a principle diagram of the suppression coefficient calculation according to the present invention;

FIG. 9 is a configuration diagram of an amplitude smoothing part in the case of using an FIR filter;

FIG. 10 is a configuration diagram of the amplitude smoothing part in the case of using an IIR filter;

FIG. 11 shows an example of a weighting factor according to the present invention;

FIG. 12 is a diagram showing a relational expression that determines a suppression coefficient from a smoothed amplitude component and an estimated noise amplitude component;

FIG. 13 is a diagram for illustrating noise estimation error according to the present invention;

FIG. 14 is a diagram for illustrating voice estimation error according to the present invention;

FIG. 15 is a waveform chart of an input signal of voice with overlapping noise;

FIG. 16 is a waveform chart of an output voice signal of the conventional noise suppressor;

FIG. 17 is a waveform chart of an output voice signal of a noise suppressor of the present invention;

FIG. 18 is a block diagram of a first embodiment of the noise suppressor of the present invention;

FIG. 19 is a block diagram of a second embodiment of the noise suppressor of the present invention;

FIG. 20 is a block diagram of a third embodiment of the noise suppressor of the present invention;

FIG. 21 is a diagram showing a nonlinear function func;

FIG. 22 is a block diagram of a fourth embodiment of the noise suppressor of the present invention;

FIG. 23 is a diagram showing the relationship between signal-to-noise ratio and the weighting factor;

FIG. 24 is a block diagram of a fifth embodiment of the noise suppressor of the present invention;

FIG. 25 is a block diagram of one embodiment of a cellular phone to which a device of the present invention is applied; and

FIG. 26 is a block diagram of another embodiment of the cellular phone to which the device of the present invention is applied.

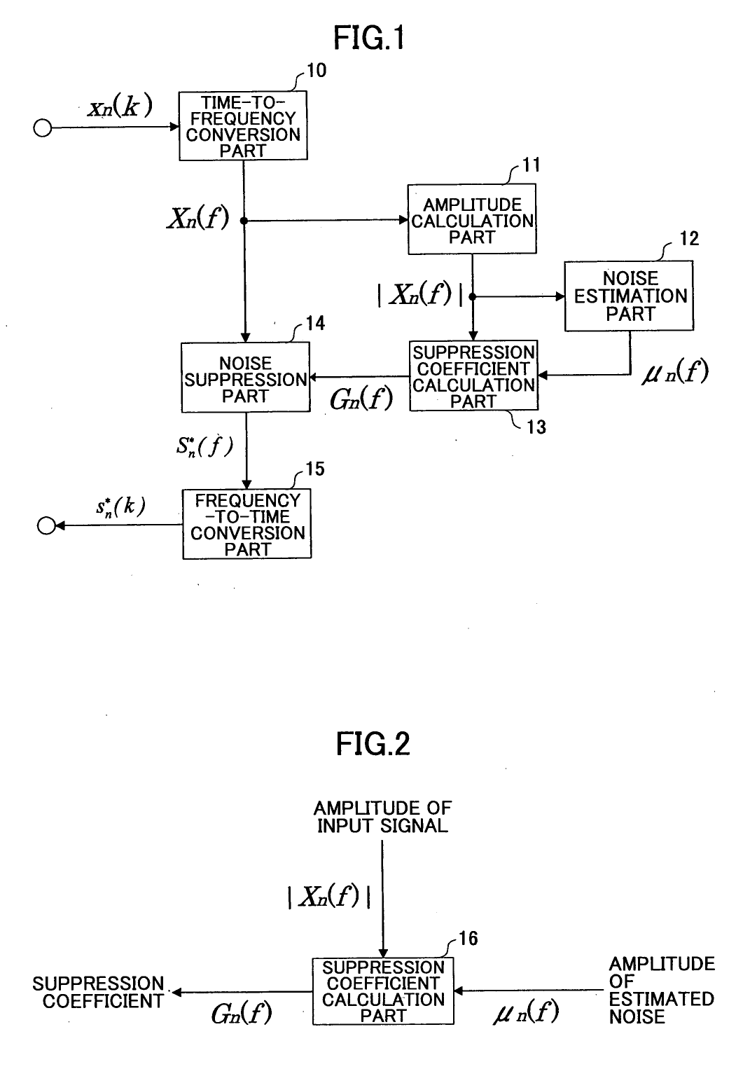

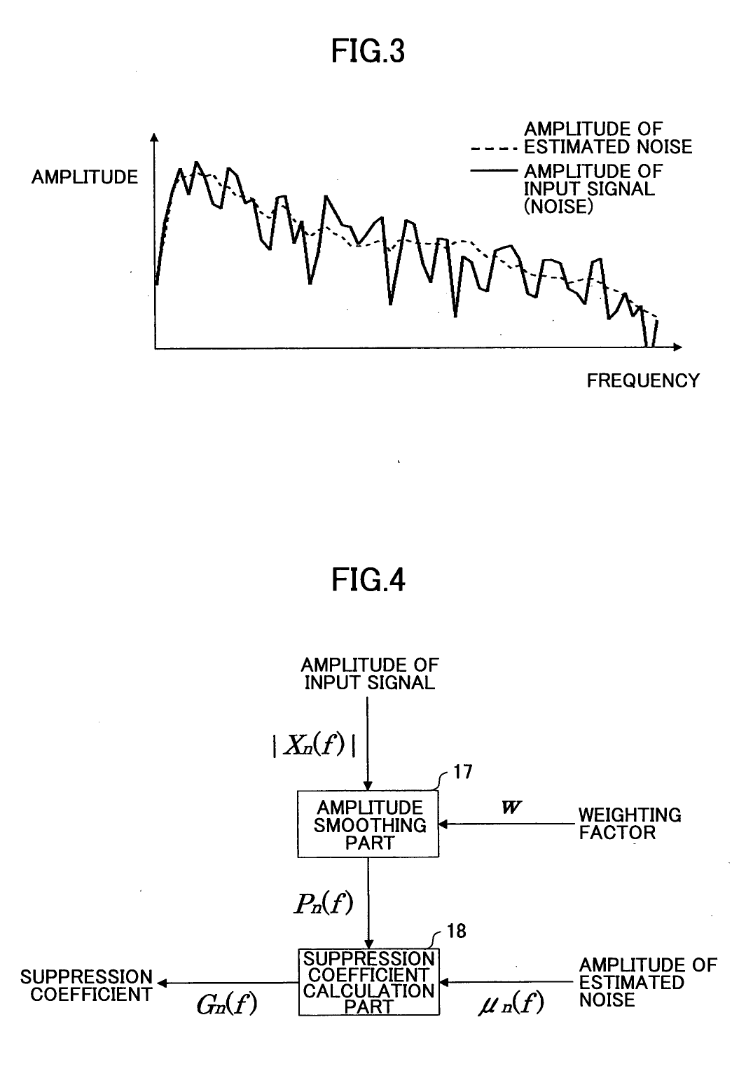

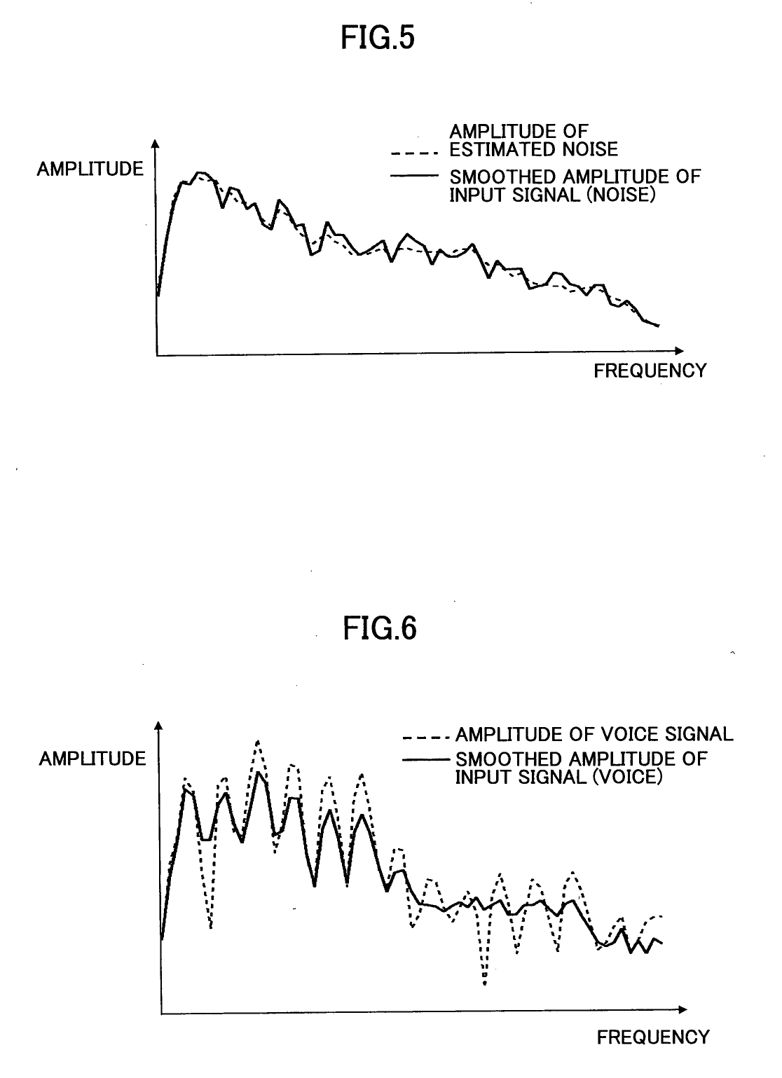

### DETAILED DESCRIPTION OF THE PREFERRED EMBODIMENTS

A description is given below, based on the drawings, of embodiments of the present invention.

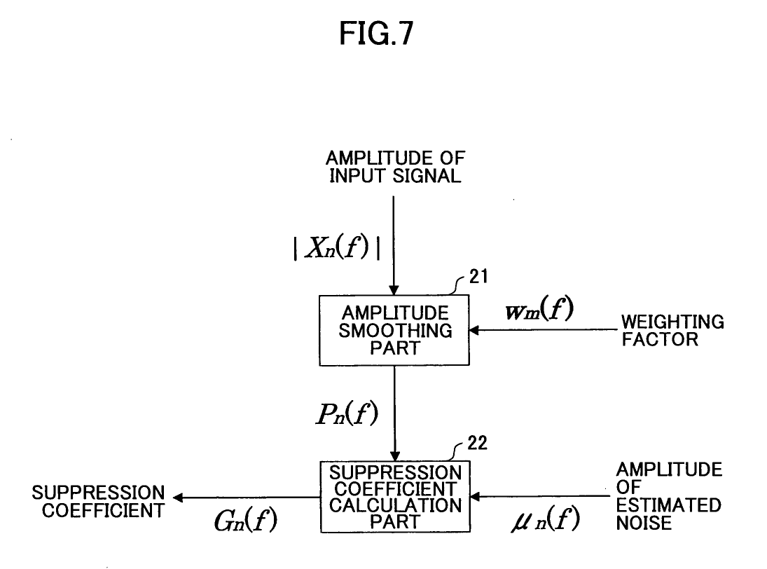

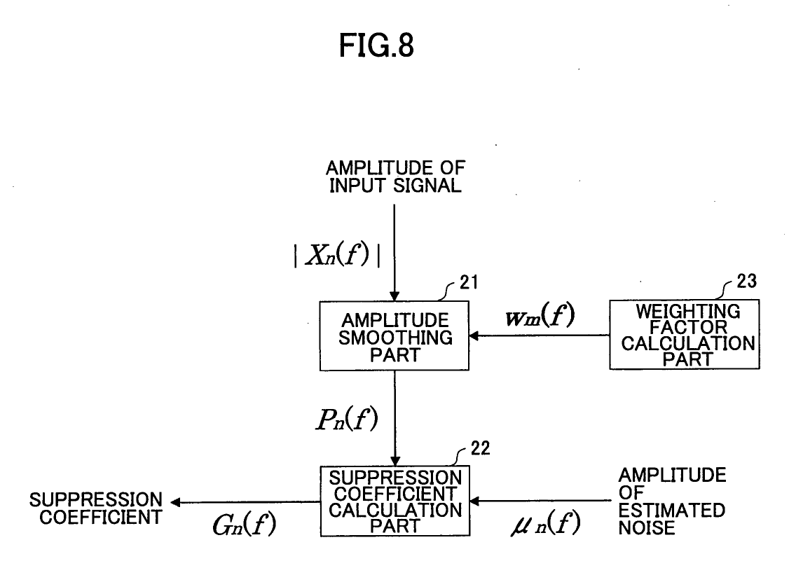

FIGS. 7 and 8 show principle diagrams of suppression coefficient calculation according to the present invention. According to the present invention, input amplitude components are smoothed before calculating a suppression coefficient the same as in FIG. 4.

In FIG. 7, an amplitude smoothing part 21 obtains the smoothed amplitude component Pₙ(f) using the amplitude component |Xₙ(f)| of the current frame n and a weighting factor wₘ(f). A suppression coefficient calculation part 22 determines the suppression coefficient Gₙ(f) based on the smoothed amplitude component Pₙ(f) and the estimated noise amplitude component μₙ(f).

In FIG. 8, a weighting factor calculation part 23 calculates features (such as a signal-to-noise ratio and the amplitude of an input signal) from an input amplitude component, and adaptively controls the weighting factor wₘ(f) based on the features. The amplitude smoothing part 21 obtains the smoothed amplitude component Pₙ(f) using the amplitude component |Xₙ(f)| of the current frame n and the weighting factor wₘ(f) from the weighting factor calculation part 23. The suppression coefficient calculation part 22 determines the suppression coefficient Gₙ(f) based on the smoothed amplitude component Pₙ(f) and the estimated noise amplitude component μₙ(f).

As smoothing methods, there are a method that uses an FIR filter and a method that uses an IIR filter, either of which may be selected in the present invention.

(In the Case of Using an FIR Filter)

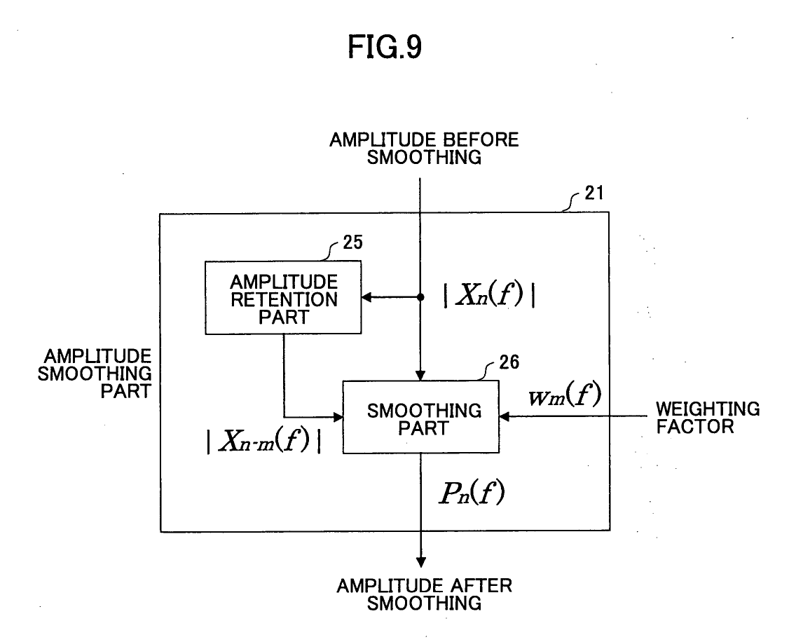

FIG. 9 shows a configuration of the amplitude smoothing part 21 in the case of using an FIR filter. In the drawing, an amplitude retention part 25 retains the input amplitude components (amplitude components before smoothing) of past N frames. Further, a smoothing part 26 determines an amplitude component after smoothing from the amplitude components of the past N frames before smoothing and the current amplitude component in accordance with Eq. (5):

$${P}_{n} ( f ) = {w}_{0} ( f ) \times \vert {X}_{n} ( f ) \vert + {\sum }_{m = 1}^{N} ( {w}_{m} ( f ) \times \vert {X}_{n - m} ( f ) \vert ) . \qquad ( 5 )$$

(In the Case of Using an IIR Filter)

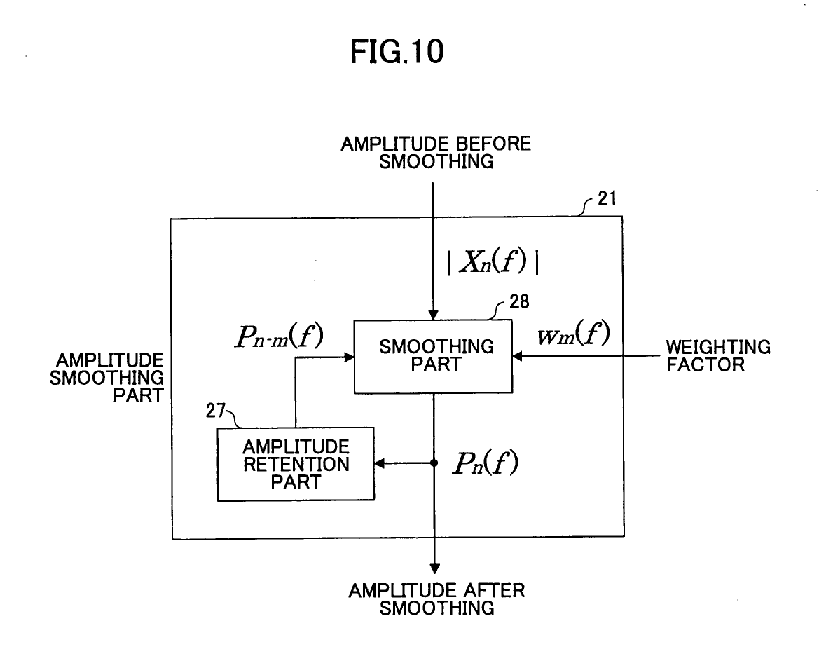

FIG. 10 shows a configuration of the amplitude smoothing part 21 in the case of using an IIR filter. In the drawing, an amplitude retention part 27 retains the amplitude components of past N frames after smoothing. Further, a smoothing part 28 determines an amplitude component after smoothing from the amplitude components of the past N frames after smoothing and the current amplitude component in accordance with Eq. (6):

$${P}_{n} ( f ) = {w}_{0} ( f ) \times \vert {X}_{n} ( f ) \vert + {\sum }_{m = 1}^{N} ( {w}_{m} ( f ) \times {P}_{n - m} ( f ) ) . \qquad ( 6 )$$

In Eqs. (5) and (6) above, m is the number of delay elements forming the filter, and w₀(f) through wₘ(f) are the respective weighting factors of m+1 multipliers forming the filter. By adjusting these values, it is possible to control the strength of smoothing at the time of smoothing an input signal.

Conventionally, as is apparent from Eqs. (3) and (4), the same weighting factor is used in all frequency bands. On the other hand, according to the present invention, the weighting factor wₘ(f) is expressed as the function of a frequency as in Eqs. (5) and (6), and is characterized in that the value differs from band to band.

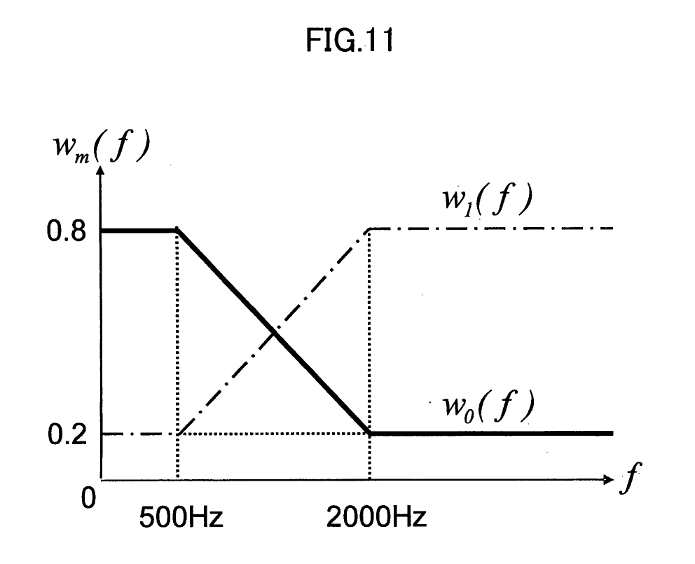

FIG. 11 shows an example of the weighting factor w₀(f) according to the present invention. In FIG. 11, it is assumed that the character of an input signal is less easily variable in low-frequency bands and easily variable in high-frequency bands. The weighting factor w₀(f) by which the amplitude component |xₙ(f)| of a current frame is multiplied is caused to be greater in value in low-frequency bands and smaller in value in high-frequency bands as indicated by a solid line, thereby following variations in high-frequency bands and causing smoothing to be stronger in low-frequency bands. In each band, the temporal sum of weighting factors is one, and in the case of W₁(f)=1−W₀(f), W₁(f) is as indicated by a one dot chain line.

Further, in conventional Eq. (4), the smoothing coefficient α as a weighting factor is a constant. Meanwhile, according to the present invention, with the weighting factor wₘ(f) being a variable, the weighing factor calculation part 23 shown in FIG. 8 calculates features such as a signal-to-noise ratio and the amplitude of an input signal from an input amplitude component, and adaptively controls the weighting factor based on the features.

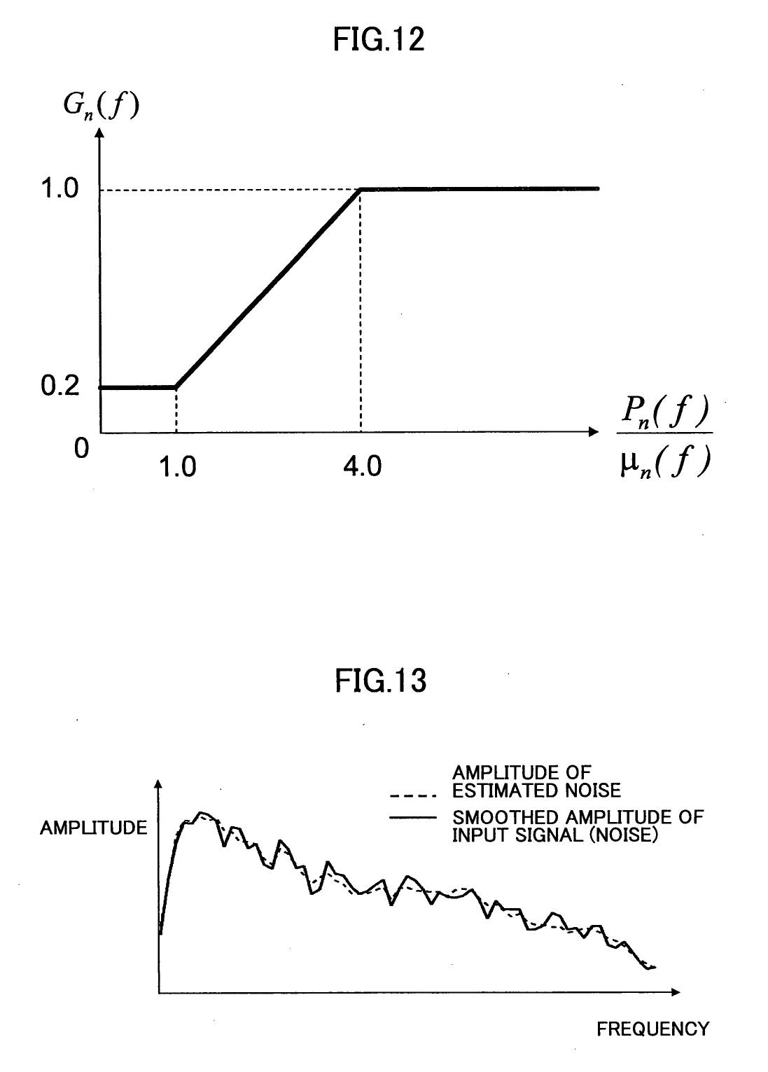

Any relational expression is selectable as the one in determining the suppression coefficient Gₙ(f) from the smoothed amplitude component Pₙ(f) and the estimated noise amplitude component μₙ(f). For example, Eq. (1) may be used. Further, a relational expression as shown in FIG. 12 may also be applied. In FIG. 12, Gₙ(f) is smaller as Pₙ(f)/μₙ(f) is smaller.

According to a noise suppressor of the present invention, the input amplitude component is smoothed before calculating a suppression coefficient. Accordingly, when there is no inputting of the voice of a speaker, it is possible to reduce noise estimation error that is the difference between the amplitude component of noise indicated by a solid line and the estimated noise amplitude component indicated by a broken line as shown in FIG. 13.

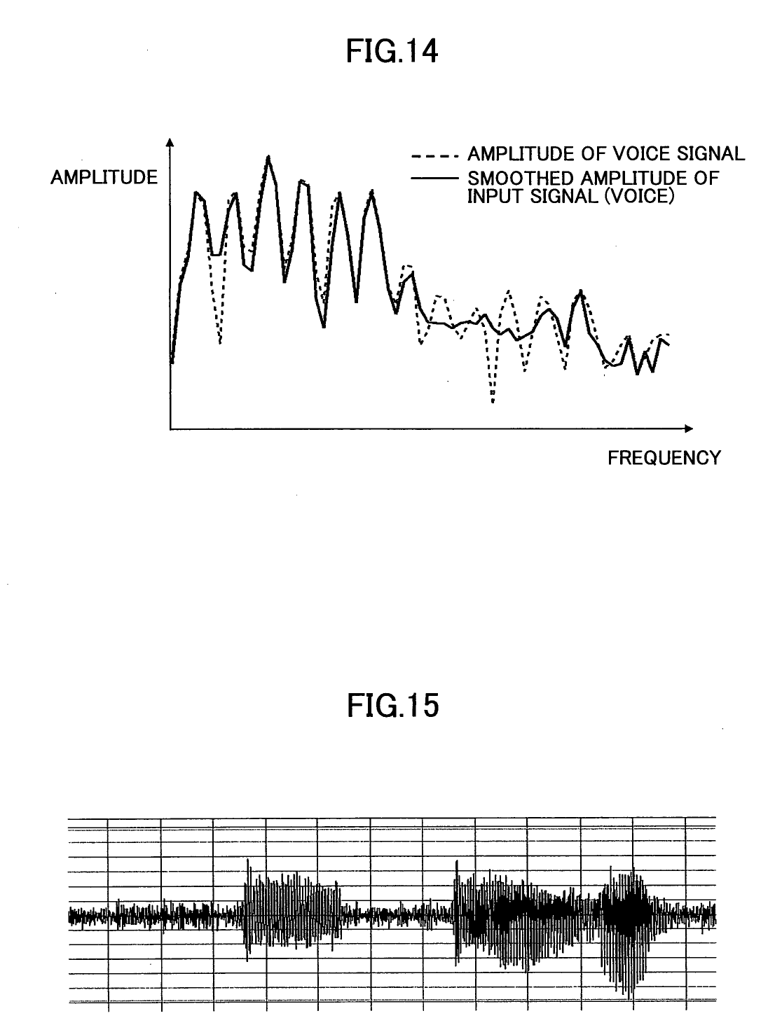

Further, when there is inputting of the voice of a speaker, it is also possible to reduce voice estimation error that is the difference between the amplitude component of a voice signal indicated by a broken line and the smoothed amplitude component indicated by a solid line as shown in FIG. 14. As a result, generation of musical noise is suppressed while minimizing effects on voice, so that it is possible to realize stable noise suppression performance.

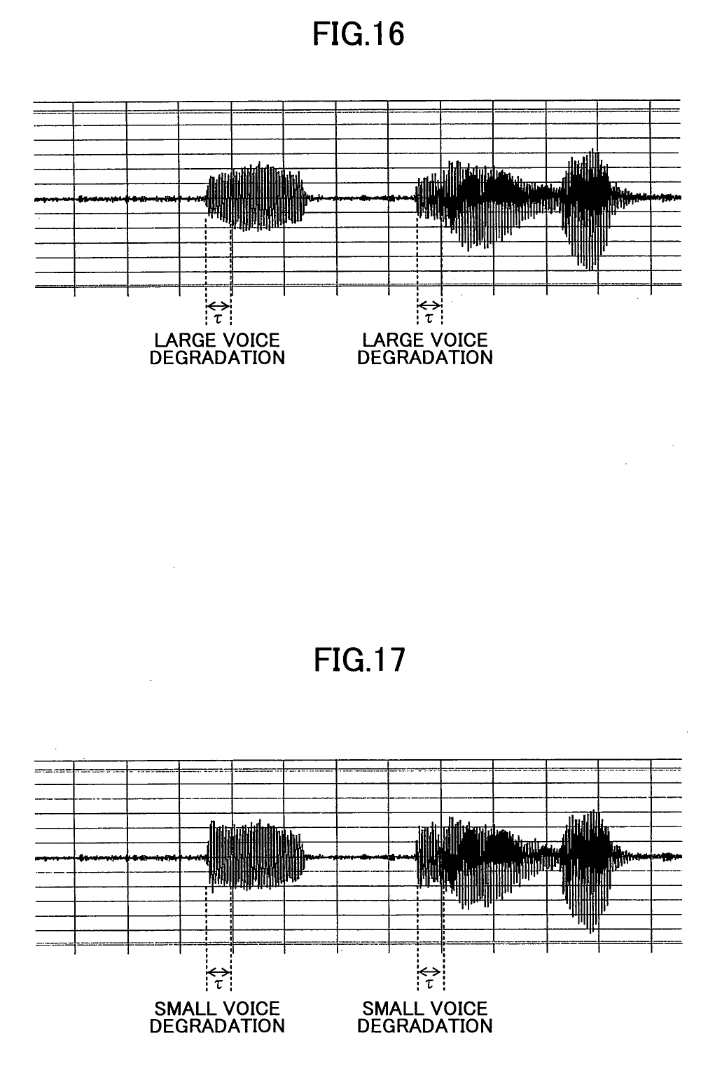

Here, when an input signal of voice with overlapping noise is provided as shown in FIG. 15, the output voice signal of the conventional noise suppressor using the suppression coefficient calculation method of FIG. 4 has a waveform shown in FIG. 16, and the output voice signal of the noise suppressor of the present invention has a waveform shown in FIG. 17.

The comparison of the waveform of FIG. 16 and the waveform of FIG. 17 shows that the waveform of FIG. 17 has small degradation in the voice head section τ. In order to compare their respective output voices, suppression performance at the time of noise input was measured in a voiceless section, and voice quality degradation at the time of voice input was measured in a voice head section, of which results are shown below.

The suppression performance at the time of noise input (measured in a voiceless section) is approximately 14 dB in the conventional noise suppressor and approximately 14 dB in the noise suppressor of the present invention. The voice quality degradation at the time of voice input (measured in the voice head section of a voice) is approximately 4 dB in the conventional noise suppressor, while it is approximately 1 dB in the noise suppressor of the present invention. Thus, there is an improvement of approximately 3 dB. As a result, the present invention can reduce voice quality degradation by reducing suppression of a voice component at the time of voice input.

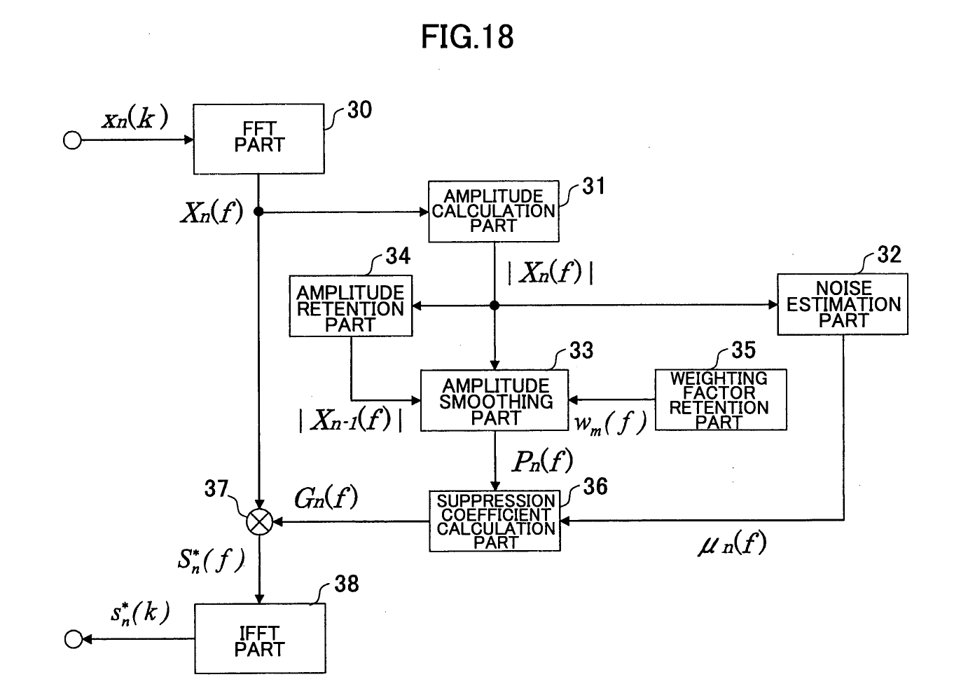

FIG. 18 is a block diagram of a first embodiment of the noise suppressor of the present invention. This embodiment uses FFT (Fast Fourier Transform)/IFFT (Inverse FFT) for channel division and synthesis, adopts smoothing with an FIR filter, and adopts Eq. (1) for calculating a suppression coefficient.

In the drawing, for each unit time (frame), an FFT part 30 converts the input signal xₙ(k) of a current frame n from a time domain k to a frequency domain f and determines the frequency domain signal Xₙ(f) of the input signal. The subscript n represents a frame number.

An amplitude calculation part 31 determines the amplitude component |Xₙ(f) from the frequency domain signal Xₙ(f). A noise estimation part 32 performs voice section detection, and determines the estimated noise amplitude component μₙ(f) from the input amplitude component |Xₙ(f)| in accordance with Eq. (7) when the voice of a speaker is not detected.

$${μ}_{n} ( f ) = \{ \begin{matrix}0.9 \times {μ}_{n - 1} ( f ) + 0.1 \times \vert {X}_{n} ( f ) \vert & \begin{matrix}at the time of \\ detecting no voice\end{matrix} \\ {μ}_{n - 1} ( f ) & \begin{matrix}at the time of \\ detecting voice\end{matrix}\end{matrix} . \qquad ( 7 )$$

An amplitude smoothing part 33 determines the averaged amplitude component Pₙ(f) from the input amplitude component |Xₙ(f)|, the input amplitude component |Xₙ₋₁(f)| of the immediately preceding frame retained in an amplitude retention part 34, and the weighting factor wₘ(f) retained in a weighting factor retention part 35 in accordance with Eq. (8), where f₃ is a sampling frequency in digitizing voice, and the weighting factor wₘ(f) is as shown in FIG. 11.

$${P}_{n} ( f ) = {w}_{0} ( f ) \times \vert {X}_{n} ( f ) \vert + {w}_{1} ( f ) \times \vert {X}_{n - 1} ( f ) \vert , \\ {w}_{0} ( f ) = \{ \begin{matrix}1.0 & if f < \frac{{f}_{s}}{8} \\ 0.8 & if \frac{{f}_{s}}{8} \leq f < \frac{{f}_{s}}{4} \\ 0.5 & if \frac{{f}_{s}}{4} \leq f\end{matrix} , \\ {w}_{1} ( f ) = 1.0 - {w}_{0} ( f ) . \qquad ( 8 )$$

A suppression coefficient calculation part 36 determines the suppression coefficient Gₙ(f) from the averaged amplitude component Pₙ(f) and the estimated noise amplitude component μₙ(f) in accordance with Eq. (9):

$${G}_{n} ( f ) = 1 - \frac{{μ}_{n} ( f )}{{P}_{n} ( f )} . \qquad ( 9 )$$

A noise suppression part 37 determines the amplitude component S*ₙ(f) after noise suppression from Xₙ(f) and Gₙ(f) in accordance with Eq. (10):
S*ₙ(f)=Xₙ(f)×Gₙ(f). (10)

An IFFT part 38 converts the amplitude component S*ₙ(f) from the frequency domain to the time domain, thereby determining a signal s*ₙ(k) after the noise suppression.

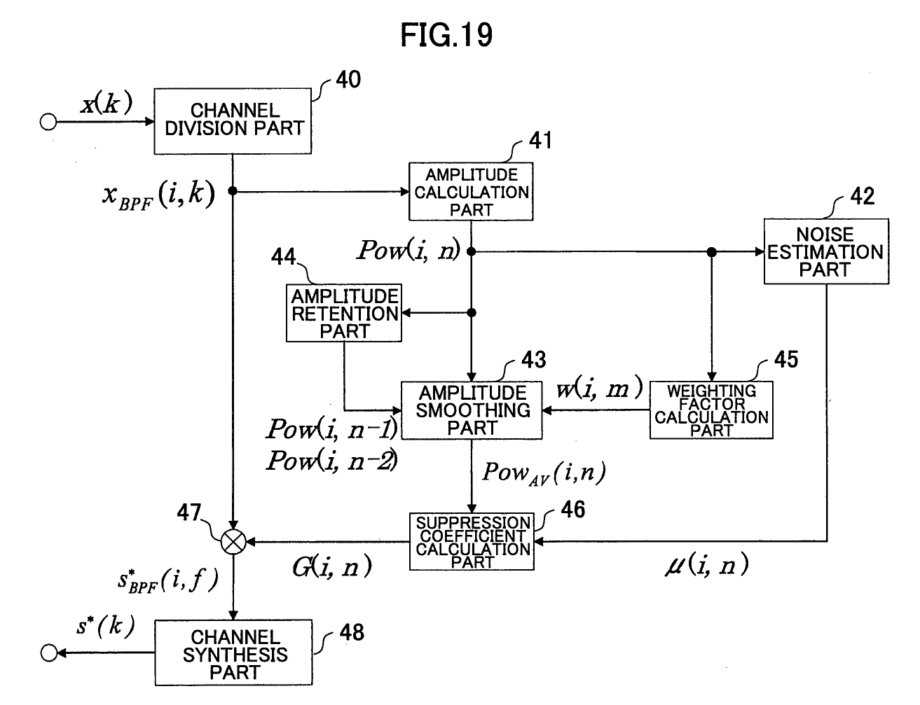

FIG. 19 is a block diagram of a second embodiment of the noise suppressor of the present invention. This embodiment uses a bandpass filter for channel division and synthesis, adopts smoothing with an FIR filter, and adopts Eq. (1) for calculating a suppression coefficient.

In the drawing, a channel division part 40 divides the input signal xₙ(k) into band signals x_{BPF}(i,k) in accordance with Eq. (11) using bandpass filters (BPFs). The subscript i represents a channel number.

$${X}_{BPF} ( i , k ) = {\sum }_{j = 0}^{M - 1} ( BPF ( i , j ) \times x ( k - j ) ) , \qquad ( 11 )$$

where BPF(i,j) is an FIR filter coefficient for band division, and M is the order of the FIR filter.

An amplitude calculation part 41 calculates a band-by-band input amplitude Pow(i,n) in each frame from the band signal x_{BPF}(i,k) in accordance with Eq. (12). The subscript n represents a frame number.

$$Pow ( i , n ) = \frac{1}{N} \times {\sum }_{l = 0}^{N - 1} {( {x}_{BPF} ( i , k - l ) )}^{2} , \qquad ( 12 )$$

where N is frame length.

A noise estimation part 42 performs voice section detection, and determines the amplitude component μ(i,n) of estimated noise from the band-by-band input amplitude component Pow(i,n) in accordance with Eq. (13) when the voice of a speaker is not detected.

$$μ ( i , n ) = \{ \begin{matrix}0.99 \times μ ( i , n - 1 ) + 0.01 \times Pow ( i , n ) & \begin{matrix}at the time of \\ detecting no voice\end{matrix} \\ μ ( i , n - 1 ) & \begin{matrix}at the time of \\ detecting voice\end{matrix}\end{matrix} . \qquad ( 13 )$$

A weighting factor calculation part 45 compares the band-by-band input amplitude component Pow(i,n) with a predetermined threshold THR1, and calculates a weighting factor w(i,m), where m=0, 1, and 2.

If Pow(i,n)≧THR1,

w(i,0)=0.7,

w(i,1)=0.2, and

w(i,2)=0.1.

If Pow(i,n)<THR1,

w(i,0)=0.4,

w(i,1)=0.3, and

w(i,2)=0.3.

That is, the temporal sum of weighting factors is one for each channel.

An amplitude smoothing part 43 calculates a smoothed input amplitude component Pow_{AV}(i,n) from band-by-band input amplitude components Pow(i,n−1) and Pow(i,n−2) retained in an amplitude retention part 44, the band-by-band input amplitude component Pow(i,n) from the amplitude calculation part 41, and the weighting factor w(i,m) in accordance with Eq. (14):

$${Pow}_{AV} ( i , n ) = {\sum }_{m = 0}^{2} ( w ( i , m ) \times Pow ( i , n - m ) ) . \qquad ( 14 )$$

A suppression coefficient calculation part 46 calculates a suppression coefficient G(i,n) from the smoothed input amplitude component Pow_{AV}(i,n) and the estimated noise amplitude component μ(i,n) by Eq. (15):

$$G ( i , n ) = 1 - \frac{μ ( i , n )}{{Pow}_{AV} ( i , n )} . \qquad ( 15 )$$

A noise suppression part 47 determines a band signal s*_{BPF}(i,k) after noise suppression from the band signal x_{BPF}(i,k) and the suppression coefficient G(i,n) in accordance with Eq. (16):
S*_{BPF}(i,k)=x_{BPF}(i,k)×G(i,n) (16)

A channel synthesis part 48 is formed of an adder circuit, and determines an output voice signal s*(k) by adding up and synthesizing the band signals S*_{BPF}(i,k) in accordance with Eq. (17):

$$s * ( k ) = {\sum }_{i = 0}^{L} ( {s}_{BPF}^{*} ( i , k ) ) , \qquad ( 17 )$$

where L is the number of band divisions.

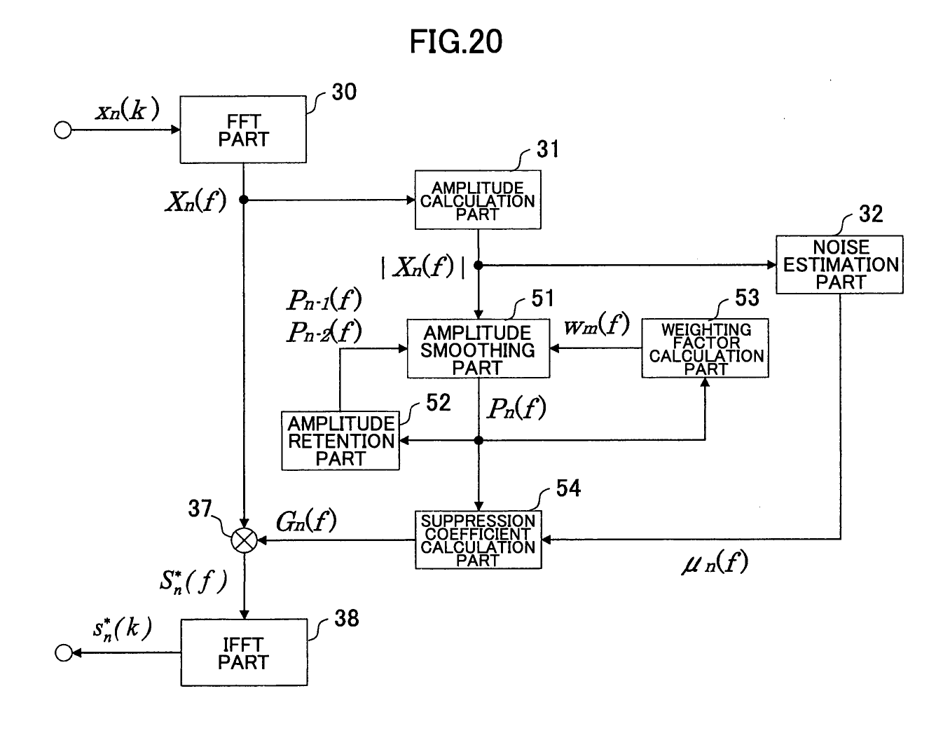

FIG. 20 shows a block diagram of a third embodiment of the noise suppressor of the present invention. This embodiment uses FFT/IFFT for channel division and synthesis, adopts smoothing with an IIR filter, and adopts a nonlinear function for calculating a suppression coefficient.

In the drawing, for each unit time (frame), the FFT part 30 converts the input signal xₙ(k) of a current frame n from a time domain k to a frequency domain f and determines the frequency domain signal Xₙ(f) of the input signal. The subscript n represents a frame number.

The amplitude calculation part 31 determines the amplitude component |Xₙ(f)| from the frequency domain signal Xₙ(f). The noise estimation part 32 performs voice section detection, and determines the estimated noise amplitude component μₙ(f) from the input amplitude component |Xₙ(f)| in accordance with Eq. (7) when the voice of a speaker is not detected.

An amplitude smoothing part 51 determines the averaged amplitude component Pₙ(f) from the input amplitude component |Xₙ(f)|, the averaged amplitude components Pₙ₋₁(f) and Pₙ₋₂(f) of the past two frames retained in an amplitude retention part 52, and the weighting factor wₘ(f) retained in a weighting factor retention part 53 in accordance with Eq. (18):
Pₙ(f)·|Xₙ(f)|w₁(f)·Pₙ₋₁(f)+w₂(f)·Pₙ₋₂(f). (18)

A weighting factor calculation part 53 compares the averaged amplitude component Pₙ(f) with a predetermined threshold THR2, and calculates the weighting factor wₘ(f), where m=0, 1, and 2.

If Pₙ(f)≧THR2,

w₀(f)=1.0,

w₁(f)=0.0, and

w₂(f)=0.0.

If Pₙ(f)<THR2,

w₀(f)=0.6,

w₁(f)=0.2, and

w₂(f)=0.2.

That is, the temporal sum of weighting factors is one for each channel.

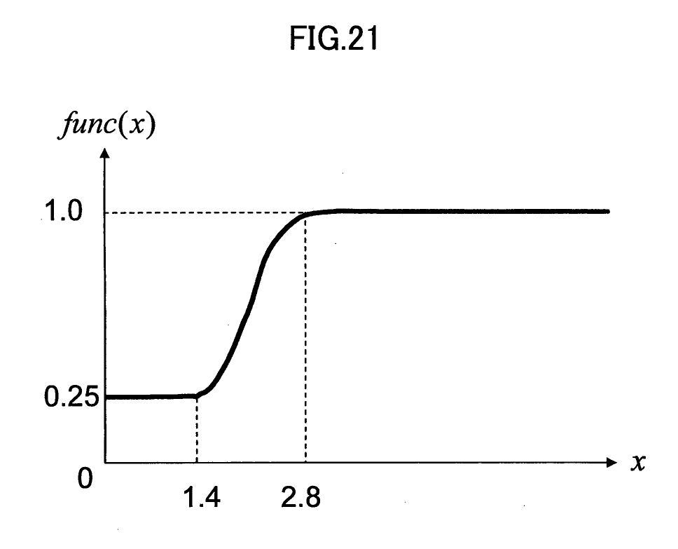

A suppression coefficient calculation part 54 determines the suppression coefficient Gₙ(f) from the averaged amplitude component Pₙ(f) and the estimated noise amplitude component μₙ(f) using a nonlinear function func shown in Eq. (19). FIG. 21 shows the nonlinear function func.

$${G}_{n} ( f ) = func ( \frac{{P}_{n} ( f )}{{μ}_{n} ( f )} ) . \qquad ( 19 )$$

The noise suppression part 37 determines the amplitude component S*ₙ(f) after noise suppression from Xₙ(f) and Gₙ(f) in accordance with Eq. (10). The IFFF part 38 converts the amplitude component S*ₙ(f) from the frequency domain to the time domain, thereby determining the signal s*ₙ(k) after the noise suppression.

Thus, by controlling the weighting factor based on an amplitude component after smoothing, it is possible to perform firm and stable control on unsteady noise.

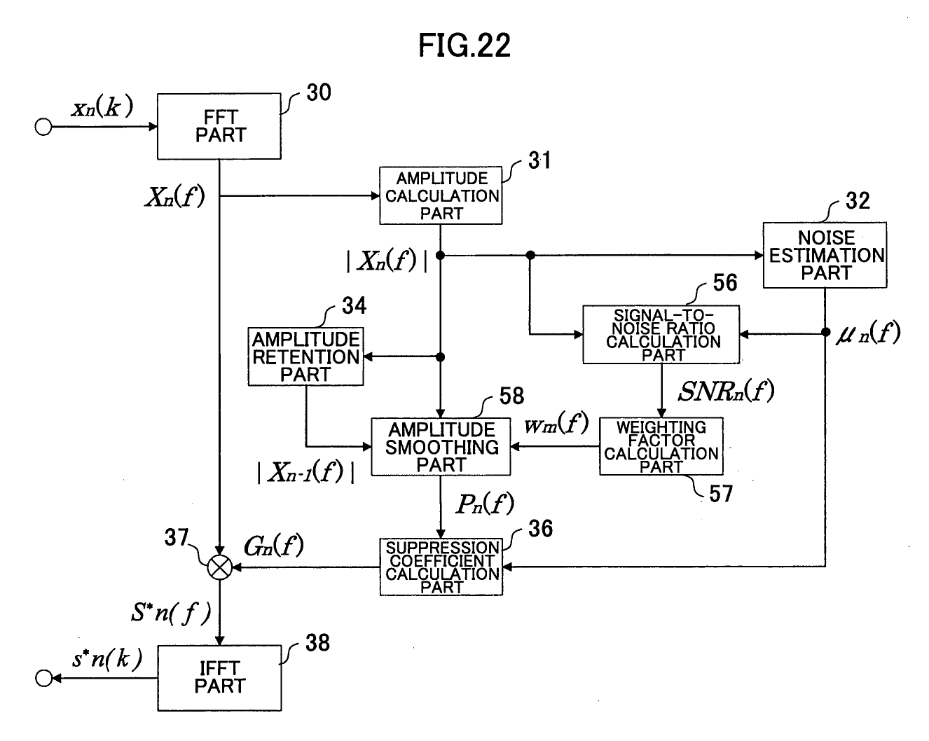

FIG. 22 shows a block diagram of a fourth embodiment of the noise suppressor of the present invention. This embodiment uses FFT/IFFT for channel division and synthesis, adopts smoothing with an FIR filter, and adopts a nonlinear function for calculating a suppression coefficient.

In the drawing, for each unit time (frame), the FFT part 30 converts the input signal xₙ(k) of a current frame n from a time domain k to a frequency domain f and determines the frequency domain signal Xₙ(f) of the input signal. The subscript n represents a frame number.

The amplitude calculation part 31 determines the amplitude component |Xₙ(f)| from the frequency domain signal Xₙ(f). The noise estimation part 32 performs voice section detection, and determines the estimated noise amplitude component μₙ(f) from the input amplitude component |Xₙ(f)| in accordance with Eq. (7) when the voice of a speaker is not detected.

A signal-to-noise ratio calculation part 56 determines a signal-to-noise ratio SNRₙ(f) band by band from the input amplitude component |Xₙ(f)| of the current frame and the estimated noise amplitude component μₙ(f) in accordance with Eq. (20):

$${SNR}_{n} ( f ) = \frac{\vert {X}_{n} ( f ) \vert}{{μ}_{n} ( f )} . \qquad ( 20 )$$

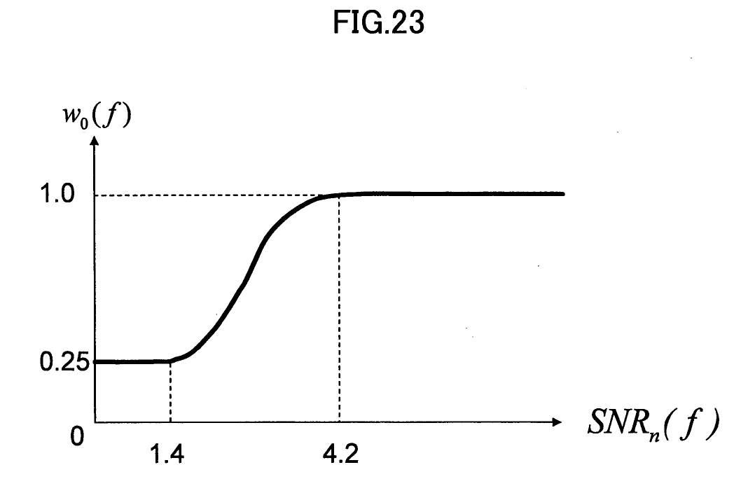

A weighting factor calculation part 57 determines the weighting factor w₀(f) from the signal-to-noise ratio SNRₙ(f). FIG. 23 shows the relationship between SNRₙ(f) and w₀(f). Further, w₁(f) is calculated from w₀(f) in accordance with Eq. (21). That is, the temporal sum of weighting factors is one for each channel.
w(f)=1.0−w₀(f). (21)

An amplitude smoothing part 58 determines the averaged amplitude component Pₙ(f) from the input amplitude component |Xₙ(f)| of the current frame, the input amplitude component |Xₙ₋₁(f)| of the immediately preceding frame retained in the amplitude retention part 34, and the weighting factor wₘ(f) from the weighting factor calculation part 57, that is, w₀(f), w₁(f), and w₂(f), in accordance with Eq. (22):
Pₙ(f)=w₀(f)·|Xₙ(f)|+w₁(f)·|Xₙ₋₁(f). (22)

The suppression coefficient calculation part 36 determines the suppression coefficient Gₙ(f) from the averaged amplitude component Pₙ(f) and the estimated noise amplitude component μₙ(f) in accordance with Eq. (9). The noise suppression part 37 determines the amplitude component S*ₙ(f) after noise suppression from Xₙ(f) and Gₙ(f) in accordance with Eq. (10). The IFFF part 38 converts the amplitude component S*ₙ(f) from the frequency domain to the time domain, thereby determining the signal s*ₙ(k) after the noise suppression.

Thus, by controlling the weighting factor based on signal-to-noise ratio, it is possible to perform stable control irrespective of the volume of a microphone.

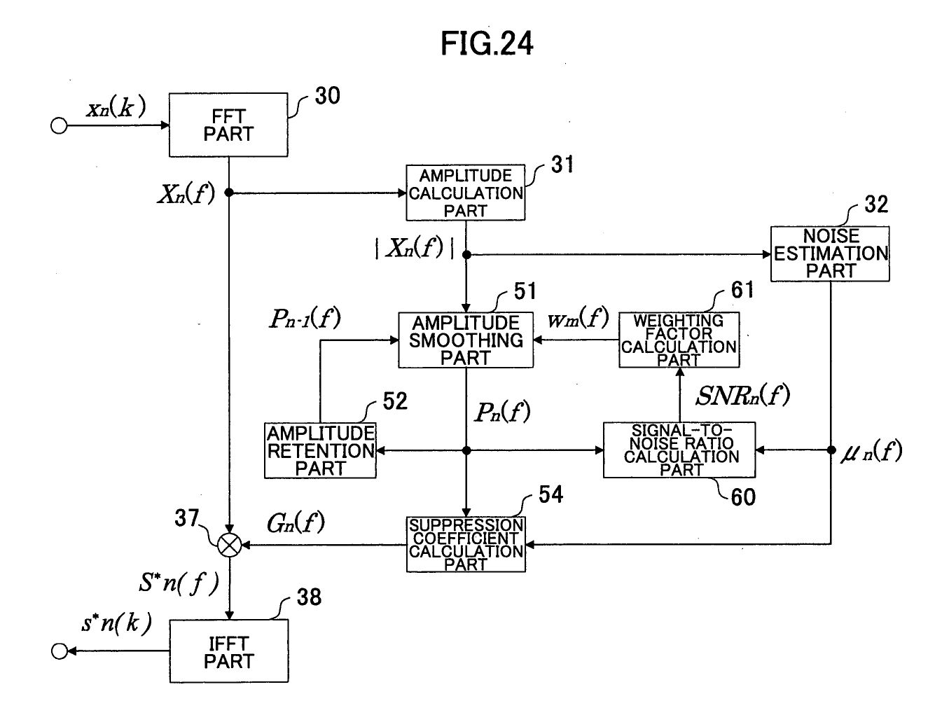

FIG. 24 shows a block diagram of a fifth embodiment of the noise suppressor of the present invention. This embodiment uses FFT/IFFT for channel division and synthesis, adopts smoothing with an IIR filter, and adopts a nonlinear function for calculating a suppression coefficient.

In the drawing, for each unit time (frame), the FFT part 30 converts the input signal xₙ(k) of a current frame n from a time domain k to a frequency domain f and determines the frequency domain signal Xₙ(f) of the input signal. The subscript n represents a frame number.

The amplitude calculation part 31 determines the amplitude component |Xₙ(f)| from the frequency domain signal Xₙ(f). The noise estimation part 32 performs voice section detection, and determines the estimated noise amplitude component μₙ(f) from the input amplitude component |Xₙ(f)| in accordance with Eq. (7) when the voice of a speaker is not detected.

The amplitude smoothing part 51 determines the averaged amplitude component Pₙ(f) from the input amplitude component |Xₙ(f)|, the averaged amplitude components Pₙ₋₁(f) and Pₙ₋₂(f) of the past two frames retained in the amplitude retention part 52, and the weighting factor wₘ(f) from a weighting factor calculation part 61 in accordance with Eq. (18).

A signal-to-noise ratio calculation part 60 determines the signal-to-noise ratio SNRₙ(f) band by band from the smoothed amplitude component Pₙ(f) and the estimated noise amplitude component μₙ(f) in accordance with Eq. (23):

$${SNR}_{n} ( f ) = \frac{{P}_{n} ( f )}{{μ}_{n} ( f )} . \qquad ( 23 )$$

The weighting factor calculation part 61 determines the weighting factor w₀(f) from the signal-to-noise ratio SNRₙ(f). FIG. 23 shows the relationship between SNRₙ(f) and w₀(f). Further, w₁(f) is calculated from w₀(f) in accordance with Eq. (21).

The suppression coefficient calculation part 54 determines the suppression coefficient Gₙ(f) from the averaged amplitude component Pₙ(f) and the estimated noise amplitude component μₙ(f) using the nonlinear function func shown in Eq. (19). The noise suppression part 37 determines the amplitude component S*ₙ(f) after noise suppression from Xₙ(f) and Gₙ(f) in accordance with Eq. (10). The IFFF part 38 converts the amplitude component S*ₙ(f) from the frequency domain to the time domain, thereby determining the signal s*ₙ(k) after the noise suppression.

Thus, by controlling the weighting factor based on signal-to-noise ratio after smoothing, it is possible to perform firm and stable control on unsteady noise, and it is possible to perform stable control irrespective of the volume of a microphone.

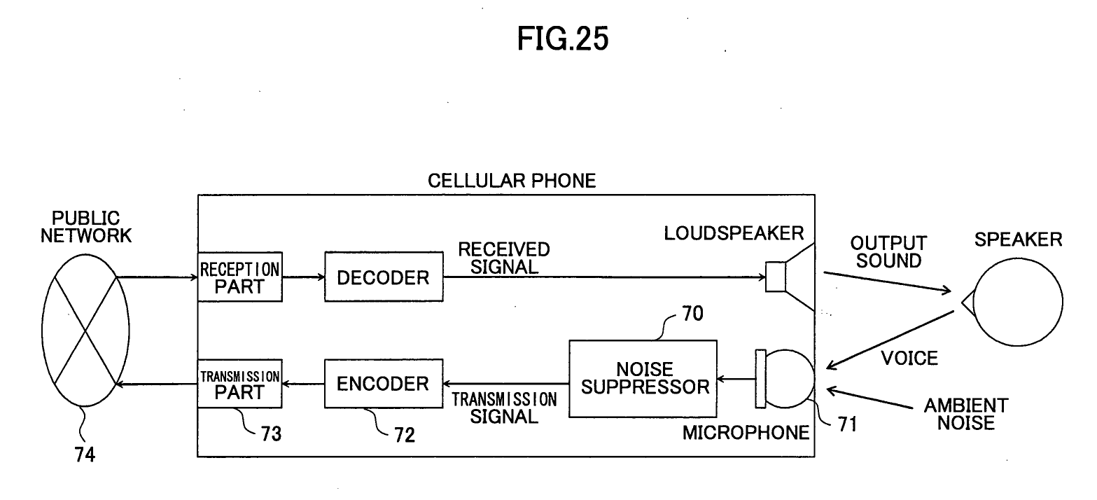

FIG. 25 shows a block diagram of one embodiment of a cellular phone to which the device of the present invention is applied. In the drawing, the output voice signal of a microphone 71 is subjected to noise suppression in a noise suppressor 70 of the present invention, and is thereafter encoded in an encoder 72 to be transmitted to a public network 74 from a transmission part.

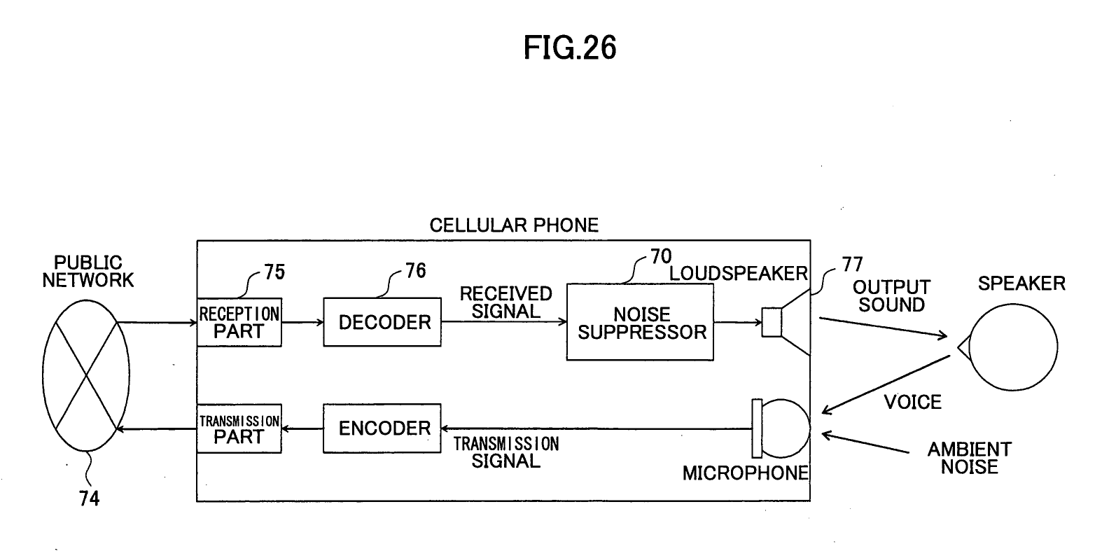

FIG. 26 shows a block diagram of another embodiment of the cellular phone to which the device of the present invention is applied. In the drawing, a signal transmitted from the public network 74 is received in a reception part 75 and decoded in a decoder 76 so as to be subjected to noise suppression in the noise suppressor 70 of the present invention. Thereafter, it is supplied to a loudspeaker 77 to generate sound.

FIG. 25 and FIG. 26 may be combined so as to provide the noise suppressor 70 of the present invention in each of the transmission system and the reception system.

The amplitude calculation parts 31 and 41 may correspond to an amplitude calculation part, the noise estimation parts 32 and 42 may correspond to a noise estimation part, the weighting factor retention part 35, the weighting factor calculation part 45, and the signal-to-noise ratio calculation parts 56 and 60 may correspond to a weighting factor generation part, the amplitude smoothing parts 33 and 43 may correspond to an amplitude smoothing part, the suppression coefficient calculation parts 36 and 46 may correspond to a suppression calculation part, the noise suppression parts 37 and 47 may correspond to a noise suppression part, the FET part 30 and the channel division part 40 may correspond to a frequency division part, and the IFFT part 38 and the channel synthesis part 48 may correspond to a frequency synthesis part.

The present invention is not limited to the specifically disclosed embodiment, and variations and modifications may be made without departing from the scope of the present invention.

What is claimed is:

1. A noise suppressor, comprising:
a frequency division part configured to divide an input signal into a plurality of bands and output band signals;
an amplitude calculation part configured to determine amplitude components of the band signals;
a noise estimation part configured to estimate an amplitude component of noise contained in the input signal and determine an estimated noise amplitude component for each of the bands;
a weighting factor generation part configured to generate a different weighting factor for each of the bands;
an amplitude smoothing part configured to determine smoothed amplitude components, the smoothed amplitude components being the amplitude components of the band signals that are temporally smoothed using the weighting factors;
a suppression calculation part configured to determine a suppression coefficient from the smoothed amplitude component and the estimated noise amplitude component for each of the bands;
a noise suppression part configured to suppress the band signals based on the suppression coefficients; and
a frequency synthesis part configured to synthesize and output the band signals of the bands after the noise suppression output from the noise suppression part.

2. The noise suppressor as claimed in claim 1, wherein the weighting factor generation part outputs the weighting factors that are preset.

3. The noise suppressor as claimed in claim 1, wherein the weighting factor generation part calculates the weighting factor based on an amplitude component of the input signal for each of the bands.

4. The noise suppressor as claimed in claim 1, wherein the weighting factor generation part calculates the weighting factor based on the smoothed amplitude component for each of the bands.

5. The noise suppressor as claimed in claim 1, wherein the weighting factor generation part calculates the weighting factor based on a ratio of an amplitude component of the input signal to the estimated noise amplitude component for each of the bands.

6. The noise suppressor as claimed in claim 1, wherein the weighting factor generation part calculates the weighting factor based on a ratio of the smoothed amplitude component to the estimated noise amplitude component for each of the bands.

7. The noise suppressor as claimed in claim 1, wherein the weighting factor generation part generates the weighting factors having a temporal sum of one.

8. The noise suppressor as claimed in claim 1, wherein:
the frequency division part is a fast Fourier transformer; and
the frequency synthesis part is an inverse fast Fourier transformer.

9. The noise suppressor as claimed in claim 1, wherein:
the frequency division part is formed of a plurality of bandpass filters; and
the frequency synthesis part is formed of an adder circuit.

10. The noise suppressor as claimed in claim 1, wherein the amplitude smoothing part weights an amplitude component of a current input signal and an amplitude component of a past input signal in accordance with the weighting factor and adds up the amplitude components for each of the bands.

11. The noise suppressor as claimed in claim 1, wherein the amplitude smoothing part weights an amplitude component of a current input signal and a past smoothed amplitude component in accordance with the weighting factor and adds up the amplitude components for each of the bands.

12. The noise suppressor as claimed in claim 1, wherein the weighting factor generation part generates the weighting factors greater in value in a low-frequency band and smaller in value in a high-frequency band.

13. A noise suppressor, comprising:
a frequency division part configured to divide an input signal into a plurality of bands and output band signals;
an amplitude calculation part configured to determine amplitude components of the band signals;
a noise estimation part configured to estimate an amplitude component of noise contained in the input signal and determine an estimated noise amplitude component for each of the bands;
a weighting factor generation part configured to cause weighting factors to temporally change and outputting the weighting factors;
an amplitude smoothing part configured to determine smoothed amplitude components, the smoothed amplitude components being the amplitude components of the band signals that are temporally smoothed using the weighting factors;
a suppression calculation part configured to determine a suppression coefficient from the smoothed amplitude component and the estimated noise amplitude component for each of the bands;
a noise suppression part configured to suppress the band signals based on the suppression coefficients; and
a frequency synthesis part configured to synthesize and output the band signals of the bands after the noise suppression output from the noise suppression part.

14. The noise suppressor as claimed in claim 13, wherein the weighting factor generation part outputs the weighting factors that are preset.

15. The noise suppressor as claimed in claim 13, wherein the weighting factor generation part calculates the weighting factor based on an amplitude component of the input signal for each of the bands.

16. The noise suppressor as claimed in claim 13, wherein the weighting factor generation part calculates the weighting factor based on the smoothed amplitude component for each of the bands.

17. The noise suppressor as claimed in claim 13, wherein the weighting factor generation part calculates the weighting factor based on a ratio of an amplitude component of the input signal to the estimated noise amplitude component for each of the bands.

18. The noise suppressor as claimed in claim 13, wherein the weighting factor generation part calculates the weighting factor based on a ratio of the smoothed amplitude component to the estimated noise amplitude component for each of the bands.

19. The noise suppressor as claimed in claim 13, wherein the weighting factor generation part generates the weighting factors having a temporal sum of one.

20. The noise suppressor as claimed in claim 13, wherein:
the frequency division part is a fast Fourier transformer; and
the frequency synthesis part is an inverse fast Fourier transformer.

21. The noise suppressor as claimed in claim 13, wherein:
the frequency division part is formed of a plurality of bandpass filters; and
the frequency synthesis part is formed of an adder circuit.

22. The noise suppressor as claimed in claim 13, wherein the amplitude smoothing part weights an amplitude component of a current input signal and an amplitude component of a past input signal in accordance with the weighting factor and adds up the amplitude components for each of the bands.

23. The noise suppressor as claimed in claim 13, wherein the amplitude smoothing part weights an amplitude component of a current input signal and a past smoothed amplitude component in accordance with the weighting factor and adds up the amplitude components for each of the bands.

24. The noise suppressor as claimed in claim 13, wherein the weighting factor generation part generates the weighting factors greater in value in a low-frequency band and smaller in value in a high-frequency band.
